(19) United States
(12) Patent Application Publication
(10) Pub. No.: US 2011/0224122 A1
(43) Pub. Date: Sep. 15, 2011

(54) Cleaning Composition and Method

(75) Inventor: Malcolm Tom McKechnie, Hull (GB)

(73) Assignee: Reckitt & Colman (Overseas) Limited, Slough, Berkshire (GB)

(21) Appl. No.: 13/055,859

(22) PCT Filed: Jun. 4, 2009
(86) PCT No.: PCT/GB2009/001405

§ 371 Date: Jun. 6, 2011

(30) Foreign Application Priority Data
Jul. 29, 2008 (GB) 0813813.3

(51) Int. Cl. C11D 3/60

(52) U.S. Cl. 510/375; 510/367

(57) ABSTRACT

A cleaning composition comprises a water-in-oil emulsion. The aqueous phase comprises a source of active oxygen. The oil phase comprises a bleach activator in particulate form.

This invention relates to cleaning compositions and cleaning methods, employing water-in-oil emulsions.

Consumers are aware that in order to achieve effective cleaning of household items and surfaces often bleaches have to be employed. The bleaches are able to act upon stains and can cause the chemical disruption (oxidation) of the stain and/or its decolouration, and thus masking of the stain. Bleaches also provide an anti-microbial action.

Bleach performance is dependent upon several factors including the type and concentration of the bleach used. One crucial factor is that of temperature. Many bleach/bleach pre-cursors only reach the required level of activity at or above a certain elevated temperature.

In order to reduce this temperature and thus make the bleaches more convenient to use whilst saving unnecessary energy bleach activators are employed. These bleach activators interact with the bleach/bleach pre-cursor, forming new bleaching species, which are more active at lower temperature.

One major issue with the use of bleach activators with bleaches is that due to the reactivity of the two compounds they must be kept separate until the desired point of use. This is relatively facile when the bleach and bleach activator is in solid form since the reaction between the two is prevented. Thus cleaning powders and compressed particulate tablets can be produced which contain both bleach and bleach activator in solid form. Additionally often the bleach and bleach activators are segregated with the composition as a further aid to prevent premature reaction.

However, certain cleaning preparations require the use of a liquid bleaching formulation. In such a case the facile separation solution cannot easily be achieved since the bleach and bleach activator are free to migrate within the liquid and will, if they come into contact, react with one another. Thus traditionally it has been necessary to provide liquid cleaning formulations in multi-chamber packs, wherein one chamber contains bleach and one chamber contains a bleach activator, so that the bleach and bleach activator are only brought into contact at the point of use. Such twin chamber packs are expensive to manufacture and cumbersome in use, requiring an unnecessary burden of dexterity from a consumer.

It is an object of the present invention to obviate/mitigate the disadvantages described above.

According to a first aspect of the present invention there is provided a cleaning composition comprising a water-in-oil emulsion, wherein the aqueous phase comprises a source of active oxygen and the oil phase comprises a bleach activator in particulate form.

With the use of a composition in accordance with the present invention it has been found that a liquid formulation may be provided which displays excellent stability before use and outstanding bleaching performance in use due to the combination of bleach and bleach activator. Additionally the exceptional performance is imparted without the need for a complex multi-chamber sales pack.

Generally the bleach activator has a particle size of 0.001 to 2 mm, e.g. such as 1 mm.

Preferably the bleach activator is TAED (Tetra Acetyl Ethylene Diamine).

The source of active oxygen is generally hydrogen peroxide.

The concentration of the hydrogen peroxide is typically from 0.1 to 50%, e.g. 15%.

Preferably the aqueous phase comprises at least 40% by weight of the composition, preferably at least 50% by weight, more preferably at least 60%, more preferably at least 70% and most preferably at least 75% by weight of the composition.

Preferably the aqueous phase comprises up to 99%, preferably up to 97% and more preferably up to 95% by weight of the composition.

In especially preferred embodiments, the aqueous phase comprises 80-90% by weight of the composition.

The oil phase preferably comprises at least 1%, more preferably at least 3%, more preferably at least 5%, and most preferably at least 7% by weight of the composition. The oil phase preferably comprises less than 15%, more preferably 12%, and most preferably less than 11% by weight of the composition. Preferably the oil phase comprises from about 7% to about 11% by weight of the composition.

The oil phase may be based on widely diverse groups of oils, including natural oils, and mixtures thereof. In this regard reference is made to co-pending European patent application published as EP-A-1749880 which describes oils suitable for forming the oil phase of the emulsion. Generally the oil phase comprises a mineral oil/hydrocarbon such as a paraffin/kerosene.

A common problem with the use of emulsions is that there is often some transport between the oil and water phases. Preferred compositions of the invention have substantially no transport between the oil and water phases. To avoid problems associated with transport between phases, the composition of the present invention preferably further comprises up to 10% by weight of a surfactant, preferably up to 8%, more preferably up to 5%, preferably up to 3%, and most preferably up to 2% by weight of the total composition. It is postulated that the surfactant forms a micelle type barrier around the water particles present in the emulsion.

Preferably the composition comprises at least 0.01% by weight surfactant, preferably at least 0.05%, more preferably at least 0.1% and most preferably at least 0.2% by weight.

The cleaning composition desirably includes at least one surfactant selected from anionic, cationic, non-ionic or amphoteric (zwitterionic) surfactants. In this regard reference is made to co-pending European patent application published as EP-A-1749880 which describes surfactants suitable for use in the emulsion.

Especially preferred surfactants are those formed by the reaction of succinic acid I or succinic anhydride II, with a polyol, a polyamine or a hydroxylamine.

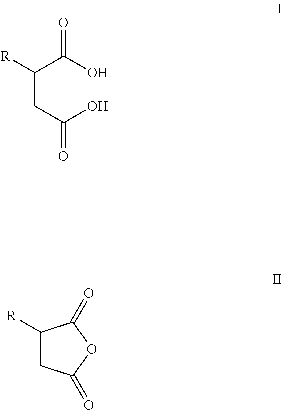

R is a hydrocarbon group having from about 12 to about 200 carbon atoms, preferably 12 to about 100 carbon atoms, more preferably 12 to 50 and most preferably 18 to 30 carbon atoms.

The hydrocarbon group R in the above formulae may be derived from an alpha-olefin or an alpha-olefin fraction. The alpha-olefins include 1-dodecene, 1-tridecene, 1-tetradecene, 1-pentadecene, 1-hexadecene, 1-heptadecene, 1-octadecene, 1-eicosene, 1-tricontene, and the like. The alpha olefin factions that are useful include C₁₅₋₁₈ alpha-olefins, C₁₂₋₁₆ alpha-olefins, C₁₄₋₁₆ alpha-olefins, C₁₄₋₁₈ alpha-olefins, C₁₆₋₁₈ alpha-olefins, C₁₈₋₂₄ alpha-olefins, C₁₈₋₃₀ alpha-olefins, and the like. Mixtures of two or more of any of the foregoing alpha-olefins or alpha-olefin fractions may be used.

In one embodiment, R in the above formulae is a hydrocarbon group derived from an olefin oligomer or polymer. The olefin oligomer or polymer may be derived from an olefin monomer of 2 to about 10 carbon atoms, and in one embodiment about 3 to about 6 carbon atoms, and in one embodiment about 4 carbon atoms. Examples of the monomers include ethylene; propylene; 1-butane; 2-butane; isobutene; 1-pentene; 1-heptene; 1-octane; 1-nonene; 1-decene; 2-pentene; or a mixture of two or more thereof.

In a preferred embodiment, R in the above formulae is a polyisobutene group. The polyisobutene group may be made by the polymerization of a C₄ refinery stream having a butene content of about 35 to about 75% by weight and an isobutene content of about 30 to about 60% by weight.

In one embodiment, R in the above formulae is a polyisobutene group derived from a polyisobutene having a high methylvinylidene isomer content, that is, at least about 50% and in one embodiment at least about 70% methylvinylidenes. Suitable high methylvinylidenes polyisobutenes include those prepared using boron trifluoride catalysts. The preparation of such polyisobutene in which the methylvinylidene isomer comprises a high percentage of the total olefin composition is described in U.S. Pat. Nos. 4,152,499 and 4,605,808, the disclosure of each of which are incorporated herein by reference.

To form the surfactant used in the present invention, those succinic acids or anhydrides are reacted with polyols, polyamines or hydroxyamines.

Suitable polyols include: ethylene glycol, diethylene glycol, triethylene glycol, tetraethylene glycol, propylene glycol, dipropylene glycol, tripropylene glycol, dibutylene glycol, tributylene glycol, 1-2-butanedoil, 2,3-dimethyl-2,3-butanediol, 2,3-butanediol, 2,3-hexanediol, 1,2-cyclohexanediol, pentaerythritol, dipentaerythritol, 1,7-heptanediol, 2,4-heptanediol, 1,2,3-hexanetriol, 1,2,5-hexantriol, 2,3,4-hexantriol, 1,2,3-butanetriol, 1,2,4-butanetriol, 2,2,6,6-tetrakis-(hydroxymethyl)cyclohexanol, 1,10-decanediol, digitalose, 2-hydroxymethyl-2-methyl-1,3-propanediol-(tri-methylolethane), or 2-hydroxymethyl-2-ethyl-1,3-propanediol-(trimethylolpropane), and the like, or mixtures thereof; sugars, starches, or mixtures thereof, for example erythritol, threitol, adonitol, xylitol, sorbitol, mannitol, erythrose, fucose, ribose, xylulose, arabinose, xylose, glycose, fructose, sorbose, mannose, sorbitan, glucosamine, sucrose, rhamnose, glyceraldehydes, galactose, and the like; glycerol, diglycerol, triglycerol, and the like, or mixtures or isomers thereof; monooleate of glycerol, monostearate of glycerol, monooleate of sorbitol, distearate of sorbitol, di-dodecanoate of erythritol, or mixtures thereof.

Suitable polyamines may be aliphatic, cycloaliphatic, heterocyclic or aromatic. Examples include alkylene polyamines and heterocyclic polyamines.

Suitable alkylene polyamines include ethylene polyamines, butylene polyamines, propylene polyamines, pentylene polyamines, etc. The higher homologues are related to heterocyclic amines such as piperazines and N-amino alkyl-substituted piperazines are also included. Specific examples of such polyamines include ethylene diamine, triethylene tetramine, tris-(2-aminoethyl)amine, propylene diamine, trimethylene diamine, tripropylene tetramine, tetraethylene pentamine, hexaethylene heptamine, pentaethylene hexamine or a mixture of two or more thereof.

The polyamine may also be selected from the heterocyclic polyamines, for example aziridines, azetidines, azolidines, tetra- and dihydropyridines, pyrroles, indoles, piperidines, imidazoles, di- and tetra-hydroimidazoles, piperazines, isoindoles, purines, morpholines, thiomorphines, N-aminoalkylmorpholines, N-aminoalkylthiomorpholines, N-aminoalkylpiperazines, N,N′-diaminoalkylpiperazines, azepines, azocines, azecines and tetra-, di- and perhydro derivatives of each of the above and mixtures thereof. Useful heterocyclic amines are the saturated 5- and 6-membered heterocyclic amines containing only nitrogen, oxygen and/or sulfur in the hetero ring, especially the piperidines, piperazines, thiomorpholines, morpholines, and pyrrolidines. Suitable compounds include piperidine, aminoalkyl-substituted piperidines, piperazine, aminoalkyl-substituted piperazines, morpholine, aminoalkyl-substituted morpholines, pyrrolidine, and N-aminoalkyl-substituted pyrrolidines such as N-aminopropylmopholine, N-aminoethylpiperazine, and N,N′-diaminoethylpiperazine.

Suitable hydroxyamines may be a primary, secondary or tertiary amine. The hydroxyamine may be an N-(hydroxyl)-substituted alkyl amine, a hydroxyl-substituted polyalkoxy analogue thereof, or a mixture of such compounds. The hydroxylamine suitably contains from about 1 to about 40 carbon atoms, preferably 1 to 20 carbon atoms, more preferably 1 to 10 carbon atoms.

Primary, secondary and tertiary hydroxyamines may be represented by the following formulae:

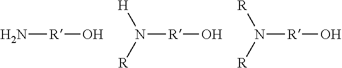

wherein each R is independently an alkyl group of one to about eight carbon atoms or hydroxyl-substituted alkyl group of about two to about 18 carbon atoms. Typically each R is a lower alkyl group of up to seven carbon atoms. The group —R′—OH in such formulae represents the hydroxyl-substituted hydrocarbon group. R′ can be an acrylic, alicyclic or aromatic group. Typically, R′ is an acyclic straight or branched alkylene group such as an ethylene, 1,2-propylene, 1,2-butylene, 1,2-octadecylene, etc, group.

When two R groups are present in the same molecule they can be joined by a direct carbon-to-carbon bond or through a heteroatom (e.g., oxygen, nitrogen or sulfur) to form a 5-, 6-, -7 or 8-members ring structure. Examples of such heterocyclic amines include N-(hydroxyl lower alkyl)morpholines, thiomorpholines, piperidines, oxazolidines, thiazolidines and the like.

The hydroxyamines may be either N-(hydroxy-substituted hydrocarbyl)amines. These may be hydroxyl-substituted poly)alkoxy)analogues of the above-described hydroxy amines (these analogues also include hydroxyl-substituted oxyalkylene analogues). Such N-(hydroxyl-substituted hydrocarbon) amines may be conveniently prepared by reaction of epoxides with afore-described amines.

Polyamine analogues of these hydroxy amines, especially alkoxylated alkylene polyamines (e.g. N,N-(diethanol)-ethylene diamine) may also be used.

Specific examples of alkoxylated alkylene polyamines include N-(2-hydroxyethyl) ethylene diamine, N,N-bis(2-hydroxyethyl)-ethylene-diamine, 1-(2-hydroxyethyl) piperazine, mono(hydroxypropyl)-substituted diethylene triamine, di(hydroxypropyl)-substituted tetraethylene pentamine, N-(3-hydroxybutyl)tetramethylene diamine, etc. Higher homologues are also useful.

Examples of the N-(hydroxyl-substituted hydrocarbyl) amines include mono-, di-, and triethanolamine, diethylethanolamine, di(3-hydroxylpropyl) amine, N-(3-hydroxybutyl) amine, N-(4-hydroxybutyl) amine, N-,N-di-(2-hydroxypropyl) amine, N-(2-hydroxylethyl) morpholine and its thio analogue, N-(2-hydroxyethyl) cyclohexylamine, N-3-hydroxyl cyclopentyl amine, o-, m- and p-aminophenol, N-(hydroxylethyl) piperazine, N,N′-di(hydroxylethyl) piperazine, and the like.

Further hydroxyamines are the hydroxy-substituted primary amines described in U.S. Pat. No. 3,576,743 by the general formula

Rₐ—NH₂

wherein Rₐ is a monovalent organic group containing at least one alcoholic hydroxy group.

Specific examples of the hydroxy-substituted primary amines include 2-amino-1-butanol, 2-amino-2-methyl-1-propanol, p-(beta-hydroxyethyl)-aniline, 2-amino-1-propanol, 3-amino-1-propanol, 2-amino-2-methyl-1,3-propanediol, 2-amino-2-ethyl-1,3-propanediol,N-(betahydroxypropyl)-N′-(beta-aminoethyl)-piperazine, tris-(hydroxymethyl) aminoethane (also known as trismethylolaminomethane),2-amino-1-butanol,ethanolamine, beta-(beta-hydroxyethoxy)-ethylamine, glucamine, glucosamine, 4-amino-3-hydroxy-3-methyl-1-butene, N-3(aminopropyl)-4-(2-hydroxyethyl)-piperadine,2-amino-6-methyl-6-heptanol, 5-amino-1-pentanol, N-(beta-hydroxyethyl)-1,3-diamino propane, 1,3-diamino-2-hydroxypropane, N-(beta-hydroxyethoxyethyl)-ethylenediamine, trismethylol amino-ethane and the like.

Hydroxyalkyl alkylene polyamines having one or more hydroxyalkyl substituents on the nitrogen atoms, are also useful. Examples include N-(2-hydroxyethyl)ethylene diamine, N,N-bis(2-hydroxyethyl) ethylene diamine, 1-2(hydroxyethyl)-piperazine, monohydroxypropyl-substituted diethylene triamine, dihydroxypropyl-substituted tetraethylene pentamine,

N-(3-hydroxybutyl) tetramethylene diamine, etc. Higher homologues are also useful.

Other preferred surfactants include span 85 (sorbital trioleate) which has an HLB value of 1.8, octylphenol-1-ethyleneancy which has an HLB value of 4.0 and span 80 sorbital monocleate which has an HLB value of 4.3.

Other known surfactants not particularly described above may also be used. Those having an HLB value of less than 10 are preferred. Such surfactants are described in McCutcheon's Detergents and Emulsifiers, North American Edition, 1982; Kirk-Othmer, Encyclopaedia of Chemical Technology, 3rd Ed., Vol. 22, pp 346-387.

The particles of TAED may be coated/may have been brought into contact with a surfactant to aid the dispersion of the TAED particles in the oil phase.

Preferred dispersants are certain nonionic surfactants which act by steric hindrance and are active only at the protectant solid/organic liquid interface and do not act as emulsifying agents. Such dispersants are suitably made up of:

(a) a polymeric chain having a strong affinity for the liquid, and

(b) a group which will absorb strongly to the solid.

Examples of such dispersants are those of the Hypermer and Atlox lines, available from the ICI group of companies, including Hypermer PS1, Hypermer PS2, Hypermer PS3, Atlox LP1, Atlox LP2, Atlox LP4, Atlox LP5, Atlox LP6, and Atlox 4912 and Agrimer polymers such as Agrimer AL-216 and AL-220, available from GAF.

The oil and or water phase of the composition may contain other detergent actives such as enzymes, builders, perfumes, optical brighteners, soil suspending agents, dye transfer inhibition agents.

According to the second aspect of the invention there is provided the use of a cleaning composition comprising a water-in-oil emulsion, wherein the aqueous phase comprises a source of active oxygen and the oil phase comprises a bleach activator in particulate form in a cleaning operation.

It will be understood that features of the first aspect of the invention will be taken to apply mutatis mutandis to the second aspect of the invention.

It has been found that in use wherein the emulsion breaks down under shear stress or dilution allowing the bleach activator to interact with the bleach.

The use is preferably for cleaning hard surfaces e.g. in a dishwashing or kitchen/bathroom/toilet/sanitary ware cleaning operation. Alternatively the use may be associated with a washing machine and be for mechanical laundry and/or dishwashing. The use may also be for hand washing e.g. manual laundry.

1. A cleaning composition comprising a water-in-oil emulsion, wherein the aqueous phase comprises a source of active oxygen and the oil phase comprises a bleach activator in particulate form.

2. A composition according to claim 1, wherein the bleach activator has a particle size of 0.001 to 2 mm.

3. A composition according to claim 1, wherein the bleach activator is TAED (Tetra Acetyl Ethylene Diamine).

4. A composition according to claim 1 wherein the source of active oxygen is hydrogen peroxide.

5. A composition according to claim 4, wherein a connect ration of the hydrogen peroxide is from 0.1 to 50%.

6. A composition according to claim 1 wherein the aqueous phase comprises at least 40% by weight of the composition.

7. A composition according to claim 1 wherein the oil phase comprises at least 1% by weight of the composition.

8. A composition according to claim 1 wherein the oil phase comprises a mineral oil/hydrocarbon.

9. A composition according to claim 1 wherein the composition comprises at least 0.01% by weight surfactant.

10. A composition according to claim 9, wherein the surfactant is a product of the reaction of succinic acid I or succinic anhydride II, with a polyol, a polyamine or a hydroxylamine.

11. A composition according to claim 1 wherein the particles of TAED may be coated or may have been brought into contact with a surfactant to aid the dispersion of the TAED particles in the oil phase.

12. A method of using a cleaning composition comprising a water-in-oil emulsion, wherein the aqueous phase comprises a source of active oxygen and the oil phase comprises a bleach activator in particulate form in a cleaning operation wherein the method comprises the step of applying the cleaning composition with a surface.

13. A composition according to claim 2, wherein the bleach activator is TAED (Tetra Acetyl Ethylene Diamine).

14. A composition according to claim 2 wherein the source of active oxygen is hydrogen peroxide.

15. A composition according to claim 6 wherein the aqueous phase comprises at least 50% by weight of the composition.

16. A composition according to claim 15 wherein the aqueous phase comprises at least 60% by weight of the composition.

17. A composition according to claim 16 wherein the aqueous phase comprises at least 70% by weight of the composition.

18. A composition according to claim 7 wherein the oil phase comprises at least 3% by weight of the composition.

19. A composition according to claim 18 wherein the oil phase comprises at least 3% by weight of the composition.
